(19) United States
(12) Patent Application Publication
(10) Pub. No.: US 2008/0154674 A1
(43) Pub. Date: Jun. 26, 2008

(54) INVENTORY MANAGEMENT SYSTEM AND METHOD

(75) Inventors: LEI LI, Shenzhen (CN); PING CHEN, Shenzhen (CN); PEI-QI LI, Shenzhen (CN); DONG LI, Shenzhen (CN); YONG XIE, Shenzhen (CN); HUI-HUI YUAN, Shenzhen (CN); TAI-WEI QUAN, Shenzhen (CN)

Correspondence Address: PCE INDUSTRY, INC.;ATT. CHENG-JU CHIANG, 458 E. LAMBERT ROAD, FULLERTON, CA, 92835, US

(73) Assignees: SHENZHEN FUTAIHONG PRECISION INDUSTRY CO., LTD., ShenZhen City (CN); SUTECH TRADING LIMITED, Tortola (VG)

(21) Appl. No.: 11/875,113

(22) Filed: Oct. 19, 2007

(30) Foreign Application Priority Data
Dec. 22, 2006 (CN) 200610157867.3

(51) Int. Cl. G06Q 10/00; G06F 17/18

(52) U.S. Cl. 705/7; 705/28

(57) ABSTRACT

An inventory management system includes a database (40) and a server (30) connected to the database. The database is configured for storing electronic inventory documents associated with information of a raw material. The server includes a loading module (302) and a processing module (304). The loading module is configured for transmitting the electronic inventory documents to the database. The processing module includes a calculating module (3041), an analysis module (3043), and an alert module (3044). The calculating module is configured for calculating a safety stock amount of the raw material. The analysis module is configured for generating an analysis signal indicating whether an on-hand inventory amount of the raw material is balanced, by comparing the on-hand inventory amount with the safety stock amount. The alert module is configured for generating an alert based on the analysis signal. An inventory management method is also provided.

### BACKGROUND OF THE INVENTION

1. Field of the Invention

The present invention relates to inventory management systems and methods, and especially to an inventory management system and method capable of calculating a safety stock amount of a raw material, and generating alerts if the on-hand inventory amount does not meet with the calculated safety stock amount.

2. Description of Related Art

In a manufacturing enterprise, keeping an appropriate stock of raw materials is a basic requirement for balanced manufacturing. If the manufacturing enterprise hold an excessive stock of the raw materials, a portion of the raw materials often become obsolete over time, which may be worthless and cause a loss to the manufacturing enterprise. If the manufacturing enterprise holds an unbalanced stock of the raw materials, lack of a critical material may occur during a period of time, thus, manufacturing operations may be broken off.

A critical function of an inventory management is to maintain the stock of the raw materials at a safety level known as “safety stock”. However, conventional inventory management systems involve a large number of manually conducted tasks. These systems are typically high labor intensive. Inevitably, numerous manual steps lead to human error and inaccurate measurement of the safety stock.

What is needed, therefore, is an improved inventory management system and method to overcome the above-described shortcomings.

### SUMMARY OF THE INVENTION

In one aspect, an inventory management system is provided. The inventory management system includes a database and a server connected to the database. The database is configured for storing electronic inventory documents associated with information of a raw material. The server includes a loading module and a processing module. The loading module is configured for transmitting the electronic inventory documents to the database. The processing module includes a calculating module, an analysis module, and an alert module. The calculating module is configured for calculating a safety stock amount of the raw material. The analysis module is configured for generating an analysis signal indicating whether an on-hand inventory amount of the raw material is balanced, by comparing the on-hand inventory amount with the safety stock amount. The alert module is configured for generating an alert according to the analysis signal.

Other advantages and novel features will become more apparent from the following detailed description when taken in conjunction with the accompanying drawings.

### BRIEF DESCRIPTION OF THE DRAWINGS

Many aspects of the present inventory management system can be better understood with reference to the following drawings. The components in the drawings are not necessarily drawn to scale, the emphasis instead being placed upon clearly illustrating the principles of the inventory management system. Moreover, in the drawings, like reference numerals designate corresponding parts throughout the diagrams.

FIG. 1 is a block diagram showing, as a whole, a construction of an inventory management system, according to a present embodiment;

FIG. 2 is a schematic diagram of a server of the inventory management system set forth in FIG. 1; and

FIG. 3 is a schematic diagram of a user interface of the inventory management system set forth in FIG. 1.

### DETAILED DESCRIPTION OF THE INVENTION

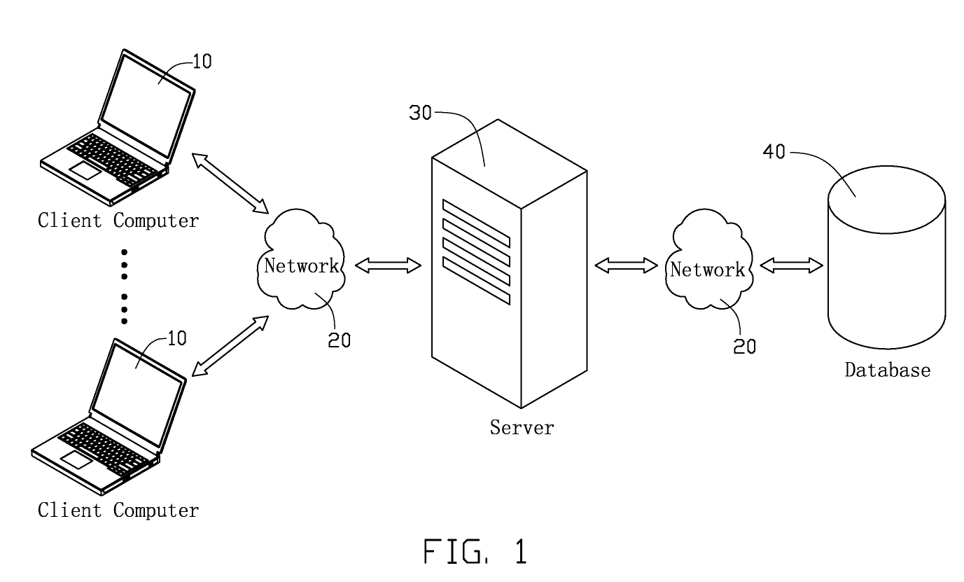

Referring to the drawings in detail, FIG. 1 schematically shows an inventory management system 100 for a raw material in accordance with a present embodiment. The system 100 includes at least one client computer 10, a communication network 20, a server 30, and a database 40. The communication network 20 electronically connects (e.g., via hard-wire and/or wireless linking) the client computer 10, the server 30, and the database 40 to each other.

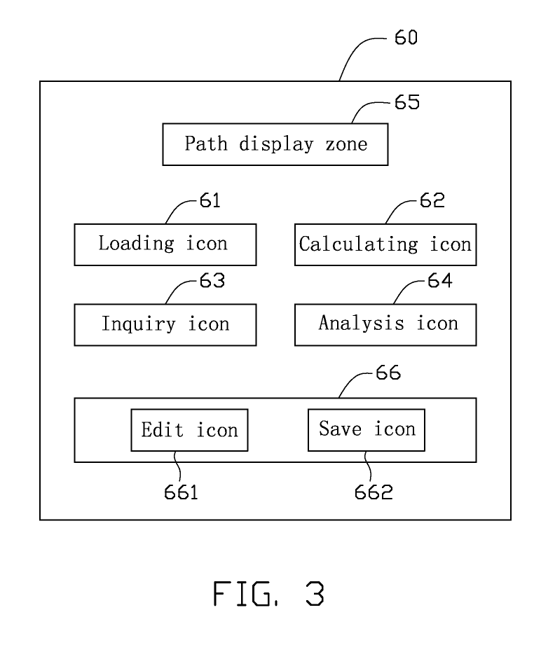

Each client computer 10 can be, for example, a personal computer (PC), a remote mainframe computer, a machine-controlled computer, a programmable logic controller (PLC), etc. Each client computer 10 advantageously includes a mail client, an inventory management software, and at least one folder, which stores electronic inventory documents associated with information of the raw material. The mail client can be a web mail system, such as Lotus Notes® (owned by Lotus Development Corporation having a principle place of business at 55 Cambridge Parkway Cambridge, Mass. 02142, USA; and IBM Corporation having a principle place of business at New Orchard Road, Armonk, N.Y. 10504, USA) system, internet-provider-based e-mail and so on. The mail client can transmit electronic mail to the server 30. When the inventory management software is activated, a user interface 60 as shown in FIG. 3 is displayed on the client computer 10 (e.g., using a display screen). A user can interact with the user interface 60 via input devices of the client computer 10. The input device can, for example, be a keyboard, a scanner, or a mouse. The user interface 60 includes a loading icon 61, a calculating icon 62, an inquiry icon 63, an analysis icon 64, a path display zone 65, a maintenance zone 66, and a keyword input box 68.

The communication networks 20 can be, for example, a local area network (LAN), a wide area network (WAN), an intranet, or the internet.

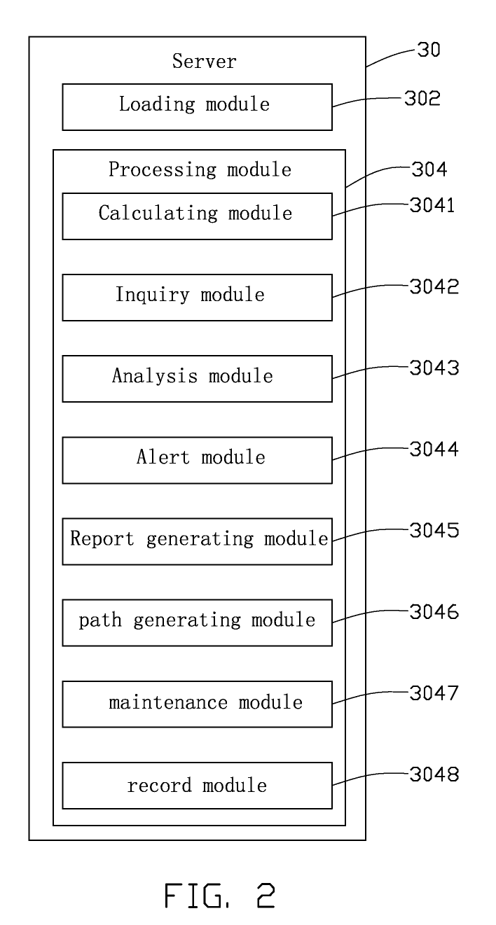

Referring to FIG. 2, the server 30 includes, at a minimum, a loading module 302 and a processing module 304.

The loading module 302 is configured for transmitting at least a selected group of electronic inventory documents stored in the predetermined folders of the client computers 10 to the database 40. The electronic inventory documents may be associated with various attributes of the raw materials, such as an on-hand inventory amount of the raw material, a consumption of the raw material, a safety factor of the raw material, and an average receipt time of the raw material. When the loading icon 61 of the user interface 60 is activated, the loading module 302 automatically transmits the at least selected group of electronic inventory documents stored in the predetermined folders of the client computers 10 to the database 40. In particular, all the electronic inventory documents stored in a given folder of the client computer 10, a selected portion of electronic inventory documents in one or more folders of the client computer 10, or all the electronic inventory documents in sum, can be selectably chosen for transmission to the database 40, depending on the situation.

The processing module 304 includes at least, a calculating module 3041, an inquiry module 3042, an analysis module 3043, an alert module 3044, a report generating module 3045, a path generating module 3046, a maintenance module 3047, and a record module 3048.

When the calculating icon 62 of the user interface 60 is activated, the calculating module 3041 automatically calculates a safety stock amount symbolized as A1, according to the electronic inventory documents transmitted to the database 40 by the loading module 302, and stores the safety stock amount to the database 40. The calculation of the safety stock amount is performed according to the safety factor of the raw material symbolized as A2, a standard deviation of the consumption of the raw material symbolized as A3, and the average receipt time of the raw material symbolized as A4. A1, A2, A3, and A4 satisfy a following formula: A1=A2*A3*square (A4). The safety factor of the raw material is co-defined by the manufacturing enterprise and suppliers of the raw material. The standard deviation of the consumption of the raw material may be a deviation amount of a maximum consumption of the raw material from a minimum consumption of the raw material during a predetermined period of time.

The inquiry module 3042 receives inquiry orders transmitted from the client computer 10, captures keywords contained in the inquiry orders, and then locates and collects related electronic inventory documents stored in the database 40, according to the captured keywords. The inquiry order can be generated when the inquiry icon 63 of the user interface 60 is activated or when the server 30 receives an e-mail from the mail client of the client computer 10. The keywords are either inputted into the keyword input box 68 of the user interface 60 by a user or contained in the e-mail. The keywords can, e.g., be a name of the raw material, a serial number of the raw material, loading time of an inventory document, and so on. Such keyword-related electronic inventory documents upon collection thereof, can then be transferred to an analysis folder of the database 40. It is, of course, understood that a single keyword could be used in some instances, and the use of just one keyword is considered to be within the scope of the present system as well. For example, when an on-hand inventory amount of the raw material is inquired by activating the inquiry icon 63, the inquiry module 3042 can collect the electronic inventory documents related to the on-hand inventory amount of the raw material and capture the information of the on-hand inventory amount of the raw material.

The analysis module 3043 is configured for determining whether the on-hand inventory amount of the raw material is balanced, by comparing the on-hand inventory amount of the raw material with the safety stock amount of the raw material. When the analysis icon 64 of the user interface 60 is activated, the analysis module 3043 automatically compares the on-hand inventory amount of the raw material with the safety stock amount of the raw material, generates an analysis signal based on the comparison between the on-hand inventory amount of the raw material and the safety stock amount of the raw material, and then transmits the analysis signal to the alert module 3044 and the report generating module 3045. The analysis signal can be one of an excess signal, an unbalance signal, and an emergency signal. When the on-hand inventory amount of the raw material is larger than the safety stock amount of the raw material, the analysis module 3043 generates the excess signal. When the on-hand inventory amount of the raw material is less than the safety stock amount of the raw material, the analysis module 3043 generates the unbalance signal, and sets a time period to replenish the raw material to reach the safety stock amount. When the raw material is not replenished to reach the safety stock amount during the time period, the analysis module 3043 generates the emergency signal.

The alert module 3044 is configured for generating one of an excess alert, an unbalance alert, and an emergency alert according to the analysis signal. The excess alert is generated based on the excess signal and indicates that the on-hand inventory amount of the raw material is excessive. The unbalance alert is generated based on the excess signal and indicates that the on-hand inventory amount of the raw material is insufficient for balance production. The emergency signal is generated based on the emergency signal and indicates that the raw material hasn't been replenished to overcome an existed insufficiency problem for more than a predetermined time period.

The report generating module 3045 is configured for generating a statistical report together with the alert of the alert module 3044 in accordance with the analysis signal. The report generating module 3045 can store the statistical report into the data base 40 and transmit the statistical report into suppliers of the raw material or an external management system (e.g., production management systems and purchasing management systems).

The path generating module 3046 is configured for generating path links indicating the locations of each related document found by the inquiry module 3042. The client computer 10 displays the path links in the path display zone 65 of the user interface 60 whenever the path links are generated by the path generating module 3046. When a user activates a path link shown in the path display zone 65, the corresponding related document of the raw material is then opened and shown on the client computer 10.

The maintenance module 3047 is configured for maintaining and updating the electronic inventory documents. When the maintenance zone 66 of the user interface 60 is activated, the maintenance module 3047 maintains and updates the electronic inventory documents. The maintenance zone 66 of the user interface 60 preferably includes an edit icon 661 and a save icon 662 placed therein. The edit icon 661 is configured for resetting an upgrading cycle time of the inventory of the raw material. When the edit icon 661 is activated, the upgrading cycle time of the inventory of the raw material can be changed via the maintenance module 3047. The save icon 662 is configured for saving the change of the upgrading cycle time of the inventory of the raw material. For example, if the upgrading cycle time of the inventory of the raw material is initialized as two weeks, the calculating module 3041 will automatically calculate a safety stock amount according to the safety factor of the raw material, a standard deviation of the consumption of the raw material symbolized, and the average receipt time of the raw material during two weeks. Understandably, the maintenance module 3047 can be configured for carrying out other ordinary maintenance operations such as copy, paste, and refresh.

The record module 3048 records maintenance and update operations executed by the maintenance module 3047 to generate a record file in a daily basis, and transmit the record file into the database 40. The record files are generated primarily for the operator reviewing the maintenance operations executed by the maintenance module 3047.

The database 40 is configured for storing electronic inventory documents and record files generated by the record module 3048.

An inventory management method is in detail as follows. Firstly, a selected group of electronic documents, which record the consumption of the raw material, the safety factor of the raw material, the on-hand inventory amount of the raw material, and the average receipt time of the raw material during an upgrading cycle time (e.g., two weeks), are loaded into the loading module 302. Secondly, the calculating module 3041 calculates a safety stock amount of the raw material according to the safety factor, a standard deviation of the consumption of the raw material, the average receipt time of the raw material. Thirdly, the analysis module 3043 compares the on-hand inventory amount of the raw material with the safety stock amount of the raw material and generates an analysis signal according to the comparison. The analysis module 3043 automatically transmits the analysis signal to the alert module 3044 and the report generating module 3045. Fourthly, the alert module 3044 generates an alert according to the analysis signal. Finally, the report generating module 3045 generates a statistical report together with the alert and transmits the statistical report into the client computer 10 or an external management system (e.g., production management systems and purchasing management systems). The suppliers of the raw material then can share the statistical report via the network 20 in real-time.

It is to be understood, however, that even though numerous characteristics and advantages of the present invention have been set forth in the foregoing description, together with details of the structure and function of the present invention, the disclosure is illustrative only, and changes may be made in detail, especially in matters of shape, size, and arrangement of parts within the principles of present invention to the full extent indicated by the broad general meaning of the terms in which the appended claims are expressed.

What is claimed is:

1. An inventory management system, comprising:
a database configured for storing electronic inventory documents associated with information of a raw material; and
a server connected to the database, the server comprising a loading module and a processing module, the loading module being configured for transmitting the electronic inventory documents to the database, the processing module comprising:
a calculating module being configured for calculating a safety stock amount of the raw material;
an analysis module being configured for generating an analysis signal indicating whether an on-hand inventory amount of the raw material is balanced, by comparing the on-hand inventory amount with the safety stock amount; and an alert module being configured for generating an alert based on the analysis signal.

2. The inventory management system as claimed in claim 1, further comprising at least one client computer connected to the server, wherein the client computer stores at least a portion of the electronic inventory documents in a predetermined folder.

3. The inventory management system as claimed in claim 2, wherein the processing module further comprises an inquiry module, the inquiry module being configured for receiving inquiry orders transmitted from the client computer, capturing keywords contained in the inquiry orders, and locating related inventory documents in the database, according to the captured keywords.

4. The inventory management system as claimed in claim 2, wherein the client computer comprises a user interface for interacting with a user.

5. The inventory management system as claimed in claim 4, wherein the user interface includes a loading icon, the loading icon being configured such that, when the loading icon is activated, the loading module automatically transmits at least a selected group of electronic inventory documents stored in a predetermined folder of the client computer to the database.

6. The inventory management system as claimed in claim 4, wherein the user interface includes a calculating icon, the calculating icon being configured such that, when the calculating icon is activated, the calculating module automatically calculates a safety stock amount of the raw material and stores the safety stock amount to the database.

7. The inventory management system as claimed in claim 4, wherein the user interface includes an analysis icon, which is configured such that, when the analysis icon is activated, the analysis module automatically generates the analysis signal by comparing the on-hand inventory amount of the raw material with the safety stock amount of the raw material and transmits the analysis signal to the alert module and the report generating module.

8. The inventory management system as claimed in claim 4, wherein the processing module further includes a path generating module, the path generating module being configured for generating a path link of a selected electronic inventory document, the user interface further comprising a path display zone to display the path link generated by the path generating module.

9. The inventory management system as claimed in claim 1, wherein the processing module further includes a report generating module, the report generating module being configured for generating a statistical report together with the alert, according to the analysis signal.

10. The inventory management system as claimed in claim 1, wherein the processing module further comprises a maintenance module, the maintenance module being configured for maintaining and updating the electronic inventory documents.

11. The inventory management system as claimed in claim 10, wherein the processing module further comprises a record module, the record module being configured for recording maintenance operations executed by the maintenance module, generating a record file, and transmitting the record file into the database.

12. An inventory management method, comprising the steps of:
loading a group of electronic inventory documents recording an on-hand inventory amount of a specific raw material, a consumption of the raw material, a safety factor of the raw material, and an average receipt time of the raw material;
calculating a safety stock amount of the raw material according to the consumption of the raw material, the safety factor of a raw material, and the average receipt time of the raw material;
comparing the on-hand inventory amount with the safety stock amount to determine whether the on-hand inventory amount of the raw material is balanced and generating an analysis signal by the comparison; and
generating an alert according to the analysis signal.

13. The inventory management method as claimed in claim 12, further comprising the step of: generating a statistical report together with the alert according to the analysis signal and transmitting the statistical report into a client computer.
